(19) United States
(12) Patent Application Publication
(10) Pub. No.: US 2017/0227033 A1
(43) Pub. Date: Aug. 10, 2017

(54) Wallboard Fastener

(71) Applicant: Allen Jordan, Chino Hills, CA (US)

(72) Inventor: Allen Jordan, Chino Hills, CA (US)

(21) Appl. No.: 15/019,385

(22) Filed: Feb. 9, 2016

(51) Int. Cl. F16B 5/06; F16B 5/02

(52) U.S. Cl. CPC F16B 5/0635; F16B 5/0258; F16B 2005/0678

(57) ABSTRACT

A fastener configured to catch the edges of a plurality of wallboards with the use of one anchoring element is disclosed. The fastener comprises a convex plate of circular shape having an anchoring hole, which is configured to allow the insertion of an anchoring element, located at the center of the convex plate. The method for using such a fastener comprises placing the fastener at a location where the surface of the convex plate covers a plurality of edges of a plurality of wallboards; inserting an anchoring element (e.g., a screw or nail) through the anchoring hole so that the anchoring element anchors onto a support element; upon completion of the insertion of an anchoring element, the surface of the convex plate will be essentially flat and flush with the surface of the plurality of boards.

### RELATED APPLICATION

Not applicable.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not Applicable.

### THE NAMES OF THE PARTIES TO A JOINT RESEARCH AGREEMENT

Not applicable.

### BACKGROUND OF THE INVENTION

1. Field

The invention relates to a fastener configured to catch the edges of a plurality of wallboards with the use of one anchoring element, such as a screw or nail. More particularly, the invention relates to a fastener comprising a convex plate of circular shape having an anchoring hole, which is configured to allow the insertion of an anchoring element, located at the center of the convex plate.

2. Description of Related Art Including Information Disclosed Under 37 C.F.R. 1.97 and 1.98

Drywalls were developed in the early 1900's to replace gypsum plaster. Gypsum plaster used a fair amount of water in its base material that required a long cure time between applications. Drywalls, on the other hand, are pre-made wallboards that could be installed more quickly with the use of screws or nails to fasten the board onto a structure.

The traditional way of installing any type of wallboard, e.g., gypsum boards, wood boards, cement or composite boards, is to screw or nail the perimeter edges of the boards along with the field. Screws and nails placed in the field typically are of less issue; however, screws and nails applied/installed at the edges of the boards can cause damage to the board face and core; for instance, pull-through (where the screw or nail is driven too deep into the boards) or a break-away (where the screw or nail is driven at a slight angle causing the board edge to break apart).

The wallboard fastener of the present invention is designed to be fastened between two or more wallboard edges and creating no damage to either wallboard edge. It also eliminates the need for one or more screws or nails at that location. The convex design of the present invention allows for an even and constant pressure to the entire surface of the fastener without damaging the board facing or core. The fastener of the present invention has more surface area holding the wallboards in place when compared to a traditional screw or nail installation. The fastener of the present invention may be used for interior or exterior walls, ceilings, or roofs.

### BRIEF SUMMARY OF THE INVENTION

It is an object of this invention to provide a fastener configured to catch the edges of a plurality of wallboards with the use of one anchoring element, such as a screw or nail.

It is a further object of this invention to provide a fastener that can reduce the number of anchoring element needed in order to install wallboards.

It is a further object of this invention to provide a fastener that remains essentially flush with the surface of the installed wallboards.

It is a further object of this invention to provide a fastener that reduce or eliminate the risk of damaging the surface of an installed wallboard caused by over-sinking of an anchoring element.

These and other objects are preferably accomplished by providing a fastener comprising a convex plate of circular shape having an anchoring hole, which is configured to allow the insertion of an anchoring element, located at the center of the convex plate. The method for using such a fastener includes placing the fastener at a location where the surface of the convex plate covers a plurality of edges of a plurality of boards; inserting an anchoring element (e.g., a screw or nail) through the anchoring hole so that the anchoring element anchors onto a support element; upon completion of the insertion of an anchoring element, the surface of the convex plate will be essentially flush with the surface of the plurality of boards.

These and other aspects of this invention will become apparent to those skilled in the art after reviewing the following description of the invention.

### BRIEF DESCRIPTION OF THE SEVERAL VIEWS OF THE DRAWINGS

The above-mentioned features and objects of the present disclosure will become more apparent with reference to the following description taken in conjunction with the accompanying drawings and images wherein like reference numerals denote like elements and in which:

FIG. 1 is a top view of a fastener in accordance with the present invention;

FIG. 2 is a side view of a fastener in accordance with the present invention;

FIG. 3 is a side view of a fastener installed with the use of an anchoring element (e.g., a screw) in accordance with the present invention;

FIG. 4 is a schematic view of multiple wallboards installed with multiple anchoring elements;

FIG. 5 is a schematic view of using the fasteners to install multiple wallboards in accordance with the present invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention. Moreover, any of the functions or steps may be outsourced to or performed by one or more third parties. Furthermore, any reference to singular includes plural embodiments, and any reference to more than one component may include a singular embodiment.

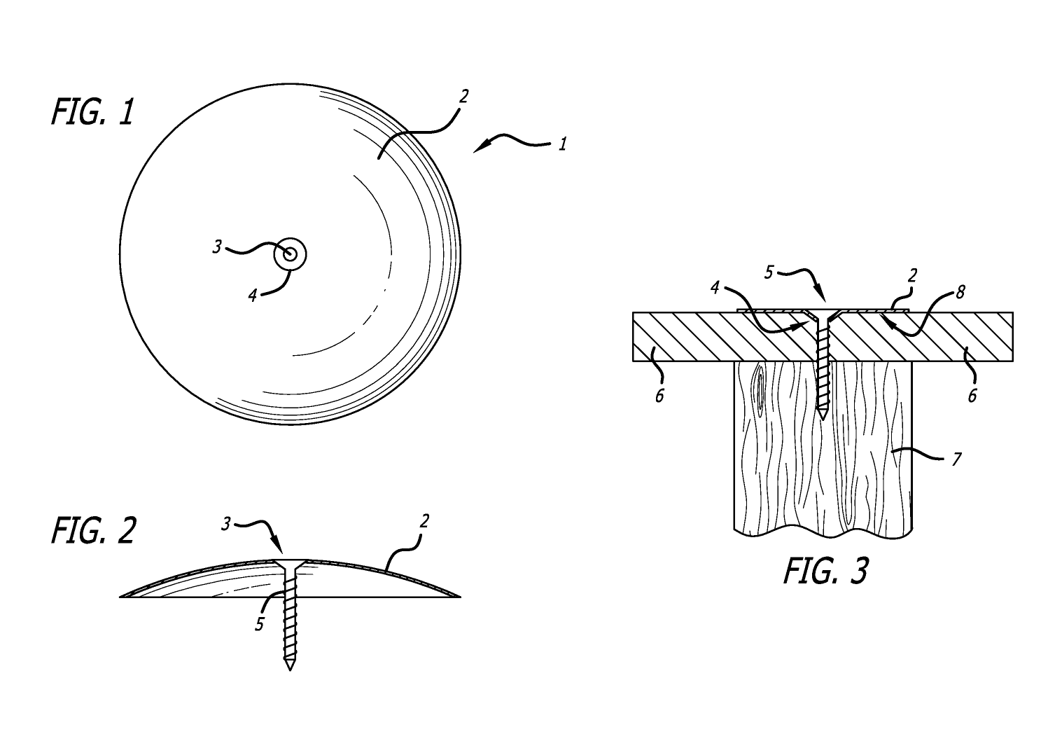

FIG. 1 illustrates a fastener 1 in accordance with the present invention comprising a convex plate 2 of circular shape having an anchoring hole 3, which is configured to allow the insertion of an anchoring element, located at the center of the convex plate 2 and an anchoring portion 4 surrounding the anchoring hole 3. FIG. 2 is a side view of the fastener described in FIG. 1 showing the convex profile of the convex plate 2 and an anchoring element 5 inserted through the anchoring hole 3.

In some embodiments, the fastener is used to install wallboards (for instance, gypsum boards). As illustrated in FIG. 3, the fastener is placed on two adjacent wallboards 6. The convex plate 2 catches the edges of both wallboards 6. One anchoring element 5 (for instance, a screw) is inserted through the anchoring hole 3 and anchors into a support element 7 (for instance, a support beam). The anchoring element 5 pushes the anchoring portion 4 downwardly by the insertion of the anchoring element 5. Upon complete insertion of the anchoring element 5, the convex plate 2 deforms and becomes essentially flat and flush with the surfaces of the wallboards 6. Because the convex plate 2 is essentially flush with the surfaces of the wallboards 6 after the anchoring element 5 is inserted, the convex plate 2 can be easily covered or masked with the wallboards through the use of, for example, masking tapes. In one embodiment, the lower surface 8 of the convex plate 2 may include additional profile, such as ribs or spikes, to increase grip or friction between the convex plate 2 and wallboards 6.

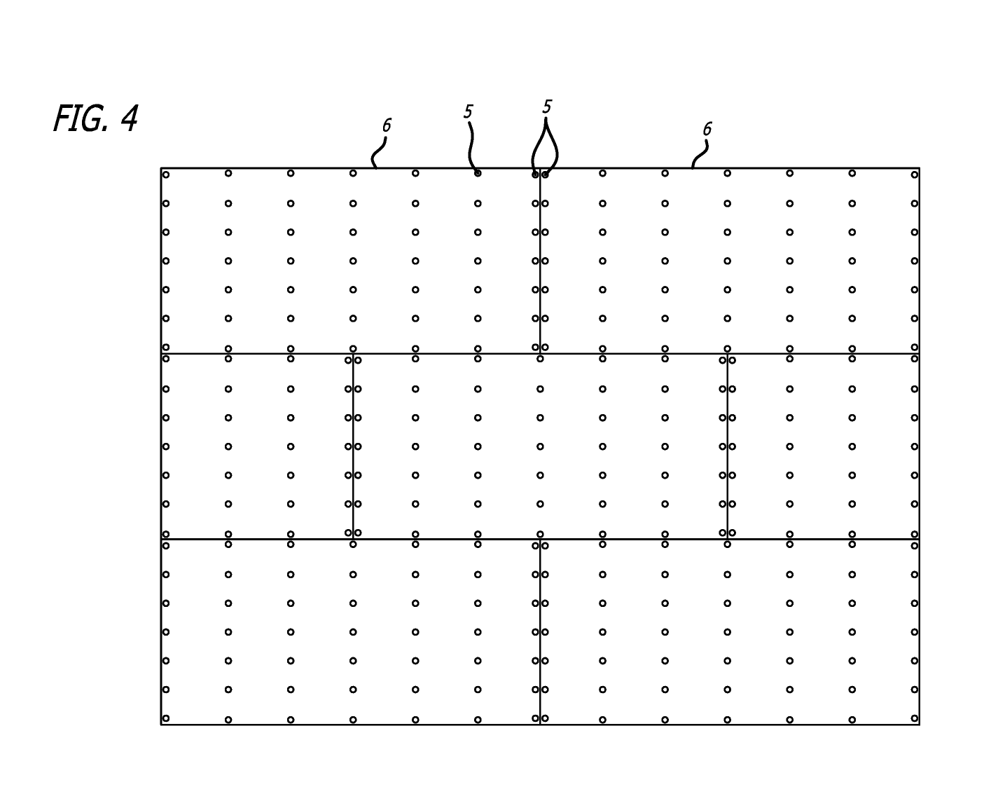

Traditionally, wallboards are installed by inserting anchoring elements (e.g., screws) into support elements (e.g., support beams). Wallboards do not share anchoring elements. A schematic view of wallboards 6 installed with only anchoring elements 5 is shown in FIG. 4,

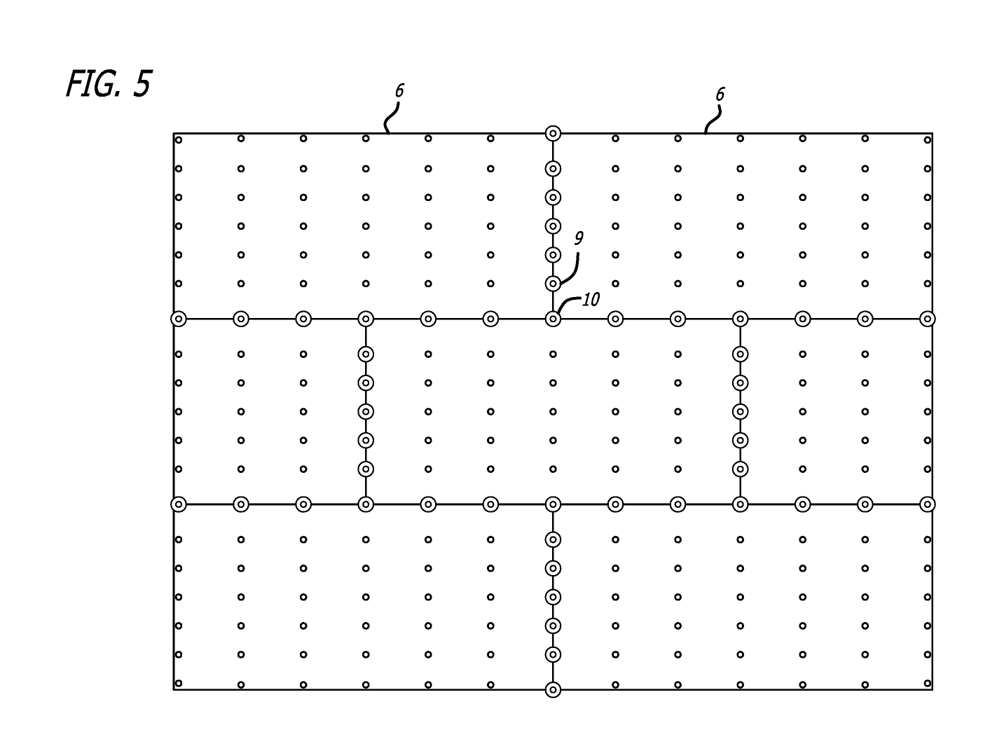

As discussed above, the fastener of the present invention is capable of catching multiple edges of multiple wallboards with only one anchoring element, thus, significantly reduces the number of anchoring element needed for wallboard installation. As illustrated in FIG. 5, fastener 9 catches the edges of two wallboards 6 and fastener 10 catches the edges of three wallboards.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

1. A fastener for catching the edges of a plurality of boards with the use of one anchoring element comprising:
a convex plate having an upper surface, a lower surface, and an anchoring hole located at the center of the convex plate and an anchoring portion surrounding the anchoring hole;
the anchoring hole is configured to allow insertion of an anchoring element;
the anchoring portion is configured to be pushed downwardly into the edges of the plurality of boards by the insertion of the anchoring element;
the upper surface of the convex plate is configured to irreversibly become essentially flat and flush with the edges of the plurality of boards upon completion insertion of the anchoring element through the anchoring hole into a support element.

2. The fastener of claim 1 wherein the lower surface the convex plate further comprising one or more rib-shaped profiles for increasing grip or friction between the convex plate and boards.

3. The fastener of claim 1 wherein the lower surface the convex plate further comprising one or more spike-shaped profiles for increasing grip or friction between the convex plate and boards.

4. A method for installing multiple boards comprising:
placing a fastener at a location where the surface of the fastener covers a plurality of edges of a plurality of boards, wherein the fastener comprising a convex plate having an upper surface, a lower surface, and an anchoring hole located at the center of the convex plate and an anchoring portion surrounding the anchoring hole; the anchoring hole is configured to allow the insertion of an anchoring element; the anchoring portion is configured to be pushed downwardly by the insertion of the anchoring element;
inserting the anchoring element through the anchoring hole so that the anchoring element anchors onto a support element;
upon complete insertion of the anchoring element onto the support element, the upper surface of the convex plate becomes essentially flat and flush with the surfaces of the plurality of boards.

5. The method of claim 4 wherein the lower surface the convex plate further comprising one or more rib-shaped profiles for increasing grip or friction between the convex plate and boards.

6. The method of claim 4 wherein the lower surface the convex plate further comprising one or more spike-shaped profiles for increasing grip or friction between the convex plate and boards.
